(19) United States
(12) Patent Application Publication
(10) Pub. No.: US 2005/0235746 A1
(43) Pub. Date: Oct. 27, 2005

(54) Algorithm for retrieval of ocean surface temperature, wind speed and wind direction from remote microwave radiometric measurements

(76) Inventor: Eric Baum, Rancho Palos Verdes, CA (US)

Correspondence Address: Eric Baum, 29528 Oceanport Rd., Rancho Palos Verdes, CA, 90275, US

(21) Appl. No.: 10/830,619

(22) Filed: Apr. 23, 2004

(51) Int. Cl. G01W 1/00

(52) U.S. Cl. 73/170.29

(57) ABSTRACT

This invention is an improved algorithm for retrieving the sea surface temperature, wind speed and wind direction from a suite of remote microwave radiometer measurements of the brightness temperature of a patch of ocean. Advantages of the method over the prior art are: (1) improved spatial resolution, (2) reduced measurement noise and, (3) removal of a source of error in the modeled wind-direction-dependence of the brightness temperature.

The prior art (see references 1-2) referenced by this invention was funded by the U.S. government and there are no known associated patents. This invention is the sole property of the inventor, receiving no support from any outside sources.

### BACKGROUND

The next-generation U.S. weather satellite, the National Polar-orbiting Operational Environmental Satellite System (NPOESS), carries the Conical-scanning Microwave Imaging/Sounder (CMIS) instrument. One of the major deliverable products (Environmental Data Records, or EDRs) from this instrument's measurements is the ocean EDR suite that includes ocean surface (skin) temperature, and wind speed and direction over the ocean. An algorithm has already been chosen by which these EDRs are derived from a suite of radiometric measurements of brightness temperature [ref. 1-2]. Each measurement is characterized by a centerline radiometer wavelength and one of the 4 Stokes polarization vectors (1^{st}, 2^{nd}, 3^{rd} or 4^{th} Stokes). Measurements at 4 wavelengths are used to infer wind speed and direction (not all polarization vectors are measured so the number of measurements, n, is smaller than the fully-populated measurement array size of 16). The same n measurements plus two additional measurements at a 5^{th} wavelength are used to infer skin temperature. The existing algorithm (in its slower-but-better form) performs retrieval in the following sequence:
1. Retrieve skin temperature Ts using a regression; a statistical fit of data to a function that is quadratic in each of the n+2 measured brightness temperatures (at 5 radiometer frequencies).
2. At small intervals in assumed wind direction, solve a model equation Tbᵢ=f(Ts, uw, φ) for each of the n theoretical brightness temperatures at a nominal wind speed and then use Newton's method to find a minimum (wrt wind speed) in a figure-of-merit (FOM) of the agreement between theory and experiment. The FOM consists of the discrepancy between measured and modeled brightness temperature, squared and summed over the n measurements. The modeled brightness temperature is a function of skin temperature Ts, wind speed uw and wind direction φ. Each candidate wind direction interval then has an associated wind speed and FOM. The candidate wind direction interval with the smallest FOM contains the most likely wind direction.

This invention addresses the following inherent weaknesses in the existing algorithm:
1. The 2 measurements at the 5^{th} radiometer wavelength that are used only in the skin temperature regression (but not elsewhere in the wind speed/direction algorithm) have an ocean surface footprint that is the largest of the 5 wavelengths. The spatial resolution of the other 4 radiometers must therefore be degraded (the measurements averaged over the largest of the footprints in the suite) in order to have all measurements refer to the same area of the ocean. This invention removes the need to use the 5^{th} radiometer wavelength for any of the ocean EDRs and thereby improves the spatial resolution.
2. The use of a regression to evaluate the ocean skin temperature uses all of the n+2 measurements to represent the physical phenomena inherent in the model equations Tbᵢ, and none can be considered redundant for the purpose of noise reduction. This invention uses the model equations for only the n brightness temperature measurements Tbᵢ (those used in the wind direction algorithm) to evaluate the skin temperature. The result is that n−2 of the measurements (as will be shown) are redundant and serve to beat down the measurement noise.
3. Evaluating the skin temperature through a regression is an imperfect process, with one of the residual errors being an artificial wind-direction-dependence of the retrieved skin temperature. This artificial directional dependence, when compared with the real directional dependence of the ocean surface emissivity in the model equations, could be large enough to become a confounding effect under some conditions. This invention evaluates the skin temperature directly from the model equations and so avoids the problem.

### SUMMARY

This invention delays the evaluation of the skin temperature so that it is evaluated together with the wind speed at each candidate wind direction. It uses an initial estimate of skin temperature and wind speed and 3 evaluations of the model equations to numerically evaluate δTbᵢ/δTs and δTbᵢ/δuw for each of the n measurement channels. The first three terms in a Taylor's series of Tbᵢ(Ts,uw) are then used to generate an expression for Tbᵢ in the neighborhood of the initial estimates. A figure-of-merit is defined, with a minimum value determining the most likely values of skin temperature and wind speed; this FOM consisting of the difference between measured brightness temperature and Tbᵢ from the Taylor's series, squared and summed over the n channels. The expression for this FOM is then minimized wrt skin temperature and with respect to wind speed to yield two algebraic equations linear in Ts and uw. This classic least-squares-optimization yields updated estimates of skin temperature and wind speed. Optionally, a final evaluation of the model equations using the updated Ts and uw values yields a more accurate evaluation of the Tbᵢ values and a better estimate of the FOM. After performing this process at all of the candidate wind directions, there has been generated an array of FOM, Ts and uw values vs wind direction. The final Ts, uw and wind direction best-guess-values correspond to the minimum FOM value.

### DESCRIPTION

For each measured brightness temperature Tbₘᵢ the corresponding theoretical brightness temperature in the neighborhood of estimated values Ts₀ and uw₀ is represented by the truncated Taylor's series
Tbᵢ≈f(Ts₀,uw₀,φ)+δTbᵢ/Ts(Ts−Ts₀)+δTbᵢ/δuw(uw−uw₀)

The partial derivatives are evaluated numerically from evaluations of the model equations using perturbed arguments, f(Ts₀+ΔTs,uw₀,φ) and f(Ts₀,uw₀+Δuw,φ). There are n of these equations and two unknowns, Ts and uw. If only two of the equations were used to equate measurement to model, Ts and uw could be determined exactly. The remaining n−2 equations are redundant, but all n of the equations can be used by asking for a “best fit” instead of an exact solution; i.e. a classical least-squares-fit of Tbᵢ to Tbₘᵢ. The difference between measurement and theory is squared and summed over the n measurements to yield the FOM,
FOM=Σ[f₀ᵢ+δTbᵢ/δTs(Ts−Ts₀)+δTbᵢ/δuw(uw−uw₀)−Tbₘᵢ]²

This is minimized wrt Ts and wrt uw in turn:
0=Σ[f₀ᵢδTbᵢ/δTs+(δTbᵢ/δTs)²(Ts−Ts₀)+δTbᵢ/δTs δTbᵢ/δuw(uw−uw₀)−δTbᵢ/δTs Tbₘᵢ]
0=Σ[f₀ᵢδTbᵢ/δuw+δTbᵢ/δuw δTbᵢ/δTs(Ts−Ts₀)+(δTbᵢ/δuw)²(uw−uw₀)−δTbᵢ/δuw Tbₘᵢ]

These are a pair of linear algebraic equations of the form
a Ts+b uw=c
that can be solved directly for those values Ts and uw that minimize the FOM. Because the model function fᵢ depends on the wind direction, the optimized values Ts and uw will vary slightly with wind direction. The candidate wind direction bin that results in the smallest minimized FOM is most likely to contain the true wind direction and the associated true values of Ts and uw.

### REFERENCES

1. T. Meissner and F. Wentz, The ocean algorithm suite for the Conical-scanning Microwave Imaging/Sounder (CMIS), Proceedings of the 2002 IEEE International Geoscience and Remote Sensing Symposium (IGARSS), Toronto, Canada
2. C. Smith, F. Wentz and T. Meissner, ATBD: CMIS Ocean EDR Algorithm Suite, Remote Sensing Systems, Santa Rosa, Calif. www.remss.com 2001

These claims refer to methods of improving prior art processes whereby a plurality of remote microwave radiometric measurements of a patch of the ocean is compared with models (that predict what the measurements should yield) to determine a best-estimate of certain ocean/atmospheric inferred-properties by minimizing a figure-of-merit (FOM) that quantifies the disagreement between measurement and model prediction. The prior art determines other ocean/atmospheric regressed-properties using regressions. Definitions are:
The i^{th} measurement is a brightness temperature Tbᵢ characterized by a centerline radiometer wavelength and a characterization of the polarization:
Inferred-properties in the prior art include wind speed and wind direction.
Regressed-properties in the prior art include ocean surface (skin) temperature Ts, as well as certain properties of the intervening atmosphere.
A regression in this context refers to an expression of the property as a function of measurements and other regressed-properties. This function contains constants that have been evaluated by optimizing comparison with data.
A model of the i^{th} measurement refers to an expression of Tbᵢ as a function of the inferred-properties with the regressed-properties assumed to be known or already evaluated using regressions.

1. A method whereby some inherent weaknesses in the prior-art processes are improved by evaluating the ocean skin temperature Ts as an inferred-property.

2. A detailed method by which Ts is evaluated as an inferred-property; the most likely wind speed (uw) and ocean skin temperature (Ts) at a candidate wind direction (φ) can be evaluated from a number (n) of independent (different wavelengths and/or polarizations) remote measurements of the brightness temperature Tbᵢ of a patch of ocean, the method comprising the steps of:
a. estimating Ts and uw (when incrementing the candidate wind direction, the values of Ts and uw obtained at the previous candidate direction can be used, while regressions can be used for the first candidate wind direction considered)
b. using a Taylor's series in powers of Ts and uw (truncated at the linear terms) to represent the brightness temperatures Tbᵢ for values of Ts and uw in the neighborhood of the estimated values, using a model equation Tbᵢ=f(Ts,uw,φ) to represent the brightness temperatures and evaluating the partial derivatives of brightness temperature wrt both Ts and uw by finite differences (but these could alternatively be evaluated term-by-term within the model function f)
c. using 2 of the measurements, Tbₘᵢ, equated to the modeled Tbᵢ of step b, to determine Ts and uw exactly, or preferably, using more than 2 measurements to evaluate a figure of merit (FOM) consisting of Σ(Tbᵢ−Tbₘᵢ)², then minimizing this FOM wrt Ts and uw in turn to produce the two equations needed to evaluate the corresponding optimized values of Ts and uw
d. considering the candidate wind speed bin that produces the smallest FOM to be the most likely to contain the true wind speed, and the corresponding values of skin temperature and wind speed obtained from step c to be the best estimates thereof.
Embodiments of this method that are less preferred but not fundamentally different include

3. Claim 2 altered by using alternate methods of obtaining the initial estimates Ts₀ and uw₀.

4. Claim 2 altered by using expansions of Tbᵢ(Ts,uw;φ) that are higher order than linear in Ts and uw.

5. Claim 2 altered by using methods of convergence toward a minimum FOM that don't rely on the local expansion, such as the method of steepest descent.

6. Claim 2 altered by using other functions of Tbᵢ−Tbₘᵢ as the FOM.

7. Any permutations of the preferred and alternate embodiments 2-6.
